(19) United States
(12) Patent Application Publication
(10) Pub. No.: US 2011/0079286 A1
(43) Pub. Date: Apr. 7, 2011

(54) Expansion Valve

(75) Inventor: Francis P. Marocchini, Somers, CT (US)

(73) Assignee: HAMILTON SUNDSTRAND CORPORATION, Windsor Locks, CT (US)

(21) Appl. No.: 12/571,615

(22) Filed: Oct. 1, 2009

(51) Int. Cl. F15D 1/00

(52) U.S. Cl. 137/1; 137/561 R

(57) ABSTRACT

A valve assembly (10) includes a housing (12) including an inlet (14) and an outlet (16). A tubular inlet spool (18) is located in the inlet (14) and has a closed downstream end (22) and a plurality of spool openings (24) through an outer surface (26) of the inlet spool (18). A tubular sleeve (28) is located over the circumference of the inlet spool (18) and is movable to substantially uncover the plurality of spool openings (24) thereby allowing a fluid flow (54) through the valve assembly (10). A method of flowing a fluid (54) through a valve assembly (10) includes urging the fluid (54) into a tubular inlet spool (18) of the valve assembly (10) to a closed downstream end (22) of the inlet spool (18). The fluid (54) is directed toward a plurality of spool openings (24) disposed in an outer surface (26) of the inlet spool (18). A tubular sleeve (28) located over the circumference of the inlet spool (18) is articulated to substantially uncover the plurality of spool openings (24), allowing the fluid (54) to flow therethrough.

### BACKGROUND OF THE INVENTION

The subject matter disclosed herein relates to refrigeration systems. More particularly, the subject matter disclosed herein relates to expansion valves for refrigeration systems.

In a typical expansion valve, an inlet and outlet of the expansion are disposed at some angular orientation to each other, for example, an angle of approximately 90 degrees between the inlet and the outlet. The valve includes a stopper which blocks flow from the inlet when the valve is in a closed position, and allows flow into the valve and out through the outlet when the valve is in an opened position. The inlet and stopper are oriented such that the direction of flow into the inlet against the stopper is substantially the same as the direction of movement of the stopper to open and/or close the valve. With the orientation as such, the stopper and the mechanism utilized to articulate the stopper must absorb all of the fluid momentum forces of the fluid entering the valve at the inlet. Thus, to control the operation of the stopper, the mechanism must be sized accordingly to overcome the fluid momentum forces acting on it. This results in larger, more powerful mechanisms being necessary. Further, the typical configuration is very sensitive to pressure and flow levels of the fluid as well as variations in pressure deltas across the valve. The art would well receive an expansion valve which reduces forces necessary to control activation of the valve, and one that is less sensitive to pressure variations across the valve.

### BRIEF DESCRIPTION OF THE INVENTION

According to one aspect of the invention, a valve assembly includes a housing including an inlet and an outlet. A tubular inlet spool is located in the inlet and has a closed downstream end and a plurality of radial spool openings through an outer surface of the inlet spool. A tubular is located over the circumference of the inlet spool and is movable to substantially uncover the plurality of spool openings thereby allowing a fluid flow through the valve.

According to another aspect of the invention, a method of flowing a fluid through a valve assembly includes urging the fluid into a tubular inlet spool of the valve assembly to a closed downstream end of the inlet spool. The fluid is then directed radial outward toward a plurality of spool openings disposed in the outer surface of the inlet spool. A tubular sleeve located over the circumference of the inlet spool is articulated to substantially uncover the plurality of spool openings, and the fluid flows through the plurality of spool openings toward an outlet of the valve assembly.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional view of an embodiment of an expansion valve;

FIG. 2 is an exploded view of an embodiment of an expansion valve; and

FIG. 3 is a cross-sectional view of an embodiment of an expansion valve in an opened position.

The detailed description explains embodiments of the invention, together with advantages and features, by way of example with reference to the drawings.

### DETAILED DESCRIPTION OF THE INVENTION

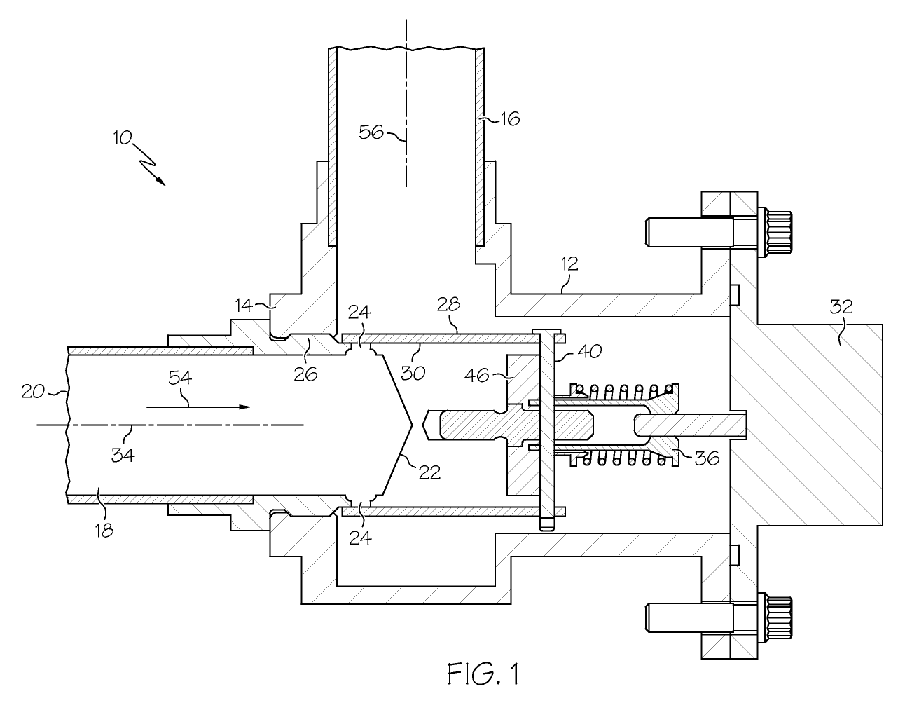

Shown in FIG. 1 is a cross sectional view of an expansion valve 10. The expansion valve 10 includes housing 12 having an inlet 14 and an outlet 16. In the embodiment shown in FIG. 1, an angle between the inlet 14 and the outlet 16 is approximately 90 degrees. It is to be appreciated, however, that other angular configurations are contemplated by the present disclosure.

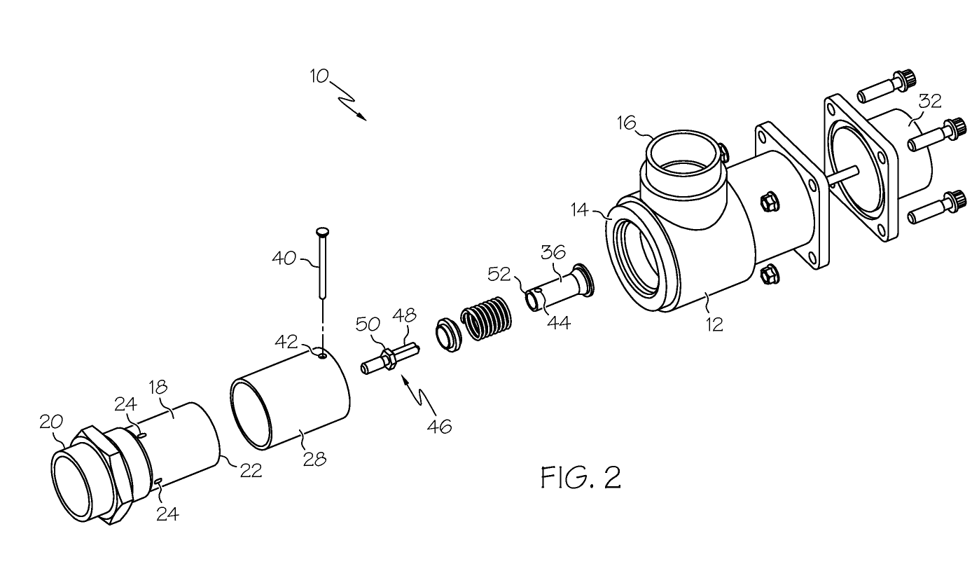

A spool 18 is disposed at the inlet 14. The spool 18 is substantially tubular in cross section and is open at an upstream end 20 and closed at a downstream end 22. The spool 18 includes a plurality of spool openings 24 extending through an outer surface 26 of the spool 18. In some embodiments, the spool openings 24 are substantially equally spaced around a circumference of the spool 18. The spool openings 24 may be substantially any cross section, for example, circular, or as shown in FIG. 2, slots. The spool 18 is insertable into the inlet 14 and secured therein such that the plurality of spool openings 24 are disposed inside of the housing 12. The spool 18 may be secured to the housing 12 via, for example, a threaded connection 26.

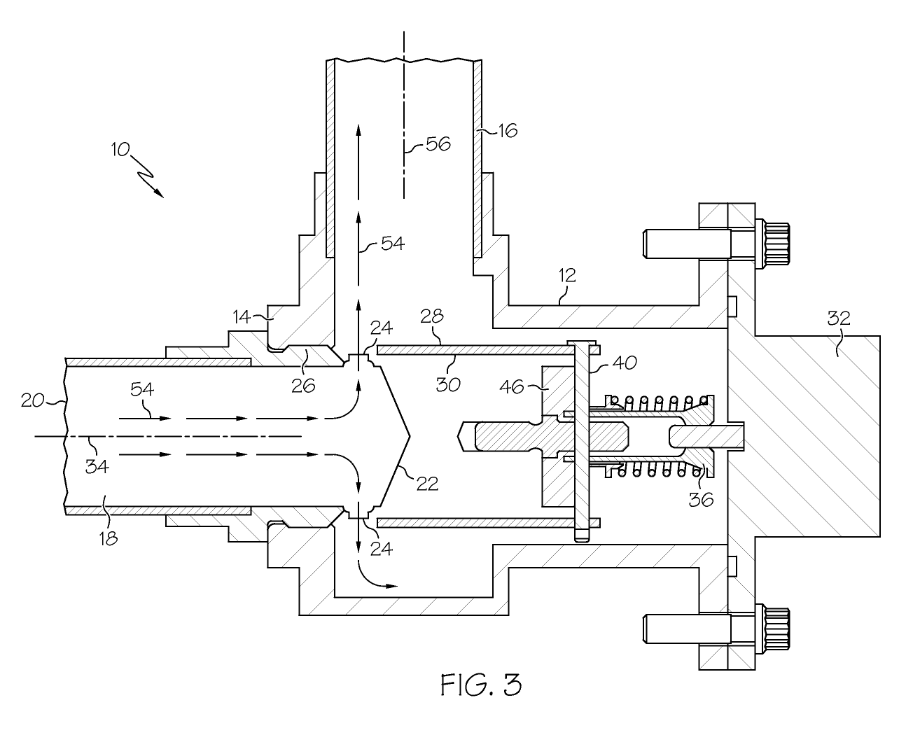

A tubular sleeve 28 is disposed in the housing 10. The sleeve 28 extends over the spool 18 such that when the valve 10 is in a closed position, as shown in FIG. 1, the sleeve 28 covers each of the spool openings 24. The outer surface 26 of the spool and an inner surface 30 of the sleeve 28 are configured to provide a desired degree of sealing at the spool openings 24 when the valve 10 is in the closed position. The sleeve 28 is connected to an activation mechanism, for example a motor 32, which articulates the sleeve 28 along an inlet axis 34 to uncover the spool openings 24 to open the valve 10, as shown in FIG. 3, and likewise cover the spool openings 24 to close the valve 10. In some embodiments, the motor 32 is a stepper motor which is capable of moving the sleeve 28 in predetermined increments.

Referring to FIG. 2, the sleeve 28 is attached to the motor 32 via one or more connecting rods 36. In some embodiments, the connecting rod 36 includes a spring loaded seat 38 to absorb backlash in the valve 10 and to maintain necessary clearances to ensure smooth operation of the valve 10. The sleeve 28 connects to the connecting rod 36 via a pin 40 that extends through sleeve holes 42 in the sleeve 28 and through corresponding rod holes 44 in the connecting rod 36. Further an anti-rotation yoke 46 may be disposed in an interior of the connecting rod 36. The yoke 46 includes tines 48 between which the pin 40 passes, and through corresponding rod holes (not shown) in the connecting rod 36. The yoke 46 includes wrenching features 50 to allow the yoke 46 to be torqued into the spool 18. The yoke 46 is fixed and retains the threaded connecting rod 36 from rotating to produce the axial translation of the sleeve 28 as an output shaft of the motor 32 rotates.

In operation, a fluid flow 54 enters the valve 10 at the inlet 14 and enters the sleeve 18 substantially parallel to the inlet axis 34. The fluid flow 54 impacts the closed downstream end 22 of the spool 18. As the fluid flow 54 impacts the downstream end 22, the fluid flow 54 momentum forces are absorbed by the spool 18 which is grounded to the housing 12. Reduction of momentum forces of the fluid flow 54 enables better control of the tubular sleeve 28. To allow the fluid flow 54 through the valve 10 and out of the outlet 16, the motor 32 is activated and the sleeve 28 is articulated along the inlet axis 34, as shown in FIG. 3, to uncover the plurality of spool openings 24. The fluid flow 54 turns substantially perpendicular to the inlet axis 34 and flows through the spool openings 24 in a direction substantially parallel to an outlet axis 56. As the fluid flow 54 passes through the spool openings 24, the fluid flow 54 impinges on an inner surface of the spool 28. Because the spool openings 24 are distributed around the circumference of the spool 28, the impingement forces are substantially in equal and opposite directions so that the resultant net force is substantially zero. In addition, both axial ends of the sleeve 18 are exposed to the same pressure environment, resulting in a pressure balanced sleeve 18. Theses features enable the tubular sleeve 18 to be exposed to reduced fluid flow and pressure variation effects, allowing for reduced forces to articulate the sleeve 18 through its required range of motion. By turning the flow from along the inlet axis 34 to along the outlet axis 56, the downstream end 22 of the spool 18 absorbs the impact forces of the fluid flow 54, rather than a valve stopper of the typical expansion valve. Further, since the sleeve openings 24 are equally spaced around the sleeve 28, side loads on the valve are reduced. In some embodiments, the downstream end 22 of the spool 18 is concave, or as shown, v-shaped in cross-section to further absorb the impact forces of the fluid flow 54.

The configurations of the valve 10 described having an axial inlet to the spool 18 and radial outlet from the spool 18 via the plurality of spool openings 24 reduces the operating forces needed by the motor 32 to articulate the sleeve 28. Since the motor 32 does not have to overcome the fluid forces acting on the sleeve 28 (as it would in a conventional expansion valve) to close and/or open the valve 10, the operating forces are reduced.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A valve assembly (10) comprising:
a housing (12) including an inlet (14) and an outlet (16);
a tubular inlet spool (18) disposed in the inlet (14) having a closed downstream end (22) and a plurality of spool openings (24) through an outer surface (26) of the inlet spool (18); and
a tubular sleeve (28) disposed over a circumference of the inlet spool (18) and articulable to substantially uncover the plurality of spool openings (24) thereby allowing a fluid flow (54) through the valve assembly (10).

2. The valve assembly (10) of claim 1 wherein the plurality of spool openings (24) are substantially equally spaced around the circumference of the inlet spool (18).

3. The valve assembly (10) of claim 1 wherein the outlet (16) is disposed such that the fluid flow (54) changes direction approximately ninety degrees between the inlet (14) and the outlet (16).

4. The valve assembly (10) of claim 1 wherein the sleeve (28) is articulable substantially along an inlet central axis (34).

5. The valve assembly (10) of claim 1 comprising a motor (32) operably connected to the sleeve (28) to articulate the sleeve (28).

6. The valve assembly (10) of claim 5 wherein the sleeve (28) is connected to the motor (32) via at least one connecting rod (36).

7. The valve assembly (10) of claim 6 wherein the at least one connecting rod (36) is disposed in the housing (12).

8. The valve assembly (10) of claim 5 wherein the motor (32) is a stepper motor.

9. The valve assembly (10) of claim 1 wherein the valve assembly (10) is an expansion valve.

10. A method of flowing a fluid (54) through a valve assembly (10) comprising:
urging the fluid (54) into a tubular inlet spool (18) of the valve assembly (10) to a closed downstream end (22) of the inlet spool (18);
directing the fluid (54) toward a plurality of spool openings (24) disposed in the outer surface (26) of the inlet spool (18);
articulating a tubular sleeve (28) disposed over the circumference of the inlet spool (18) to substantially uncover the plurality of spool openings (24); and
flowing the fluid (54) through the plurality of spool openings (24) toward an outlet (16) of the valve assembly (10).

11. The method of claim 10 comprising absorbing fluid impact forces in the closed downstream end (22) of the inlet spool (18).

12. The method of claim 10 wherein the fluid (54) is directed substantially radially outwardly toward the plurality of spool openings (24).

13. The method of claim 10 wherein the plurality of spool openings (24) are substantially equally spaced around a circumference of the inlet spool (18).

14. The method of claim 10 wherein the sleeve (28) is articulated substantially along an inlet central axis (34).

15. The method of claim 10 wherein the sleeve (28) is articulated via a motor (32) in operable communication with the sleeve (28).

16. The method of claim 15 wherein operation of the motor (32) articulates a connecting rod (36) connected to the sleeve (28).

17. The method of claim 15 wherein the motor (32) is a stepper motor.

18. The method of claim 10 wherein the fluid flow (54) changes direction approximately ninety degrees between the inlet (14) and the outlet (16).
